(19) United States
(12) Patent Application Publication
(10) Pub. No.: US 2008/0289887 A1
(43) Pub. Date: Nov. 27, 2008

(54) SYSTEM AND METHOD FOR REDUCING VIBRATIONAL EFFECTS ON A FORCE-BASED TOUCH PANEL

(75) Inventors: Randy Flint, Kaysville, UT (US); David A. Soss, Salt Lake City, UT (US)

Correspondence Address: THORPE NORTH & WESTERN, LLP., P.O. Box 1219, SANDY, UT, 84091-1219, US

(73) Assignee: QSI Corporation, Salt Lake City, UT (US)

(21) Appl. No.: 12/125,762

(22) Filed: May 22, 2008

Related U.S. Application Data
(60) Provisional application No. 60/931,400, filed on May 22, 2007.

(51) Int. Cl. G06F 3/041

(52) U.S. Cl. 178/18.03

(57) ABSTRACT

A system and method for reducing vibrational effects on a force-based touch panel is disclosed. The system comprises at least one force sensor operable with the force-based touch panel to measure a force applied to the touch panel to provide at least one force sensor signal. An accelerometer operable with the force-based touch panel is used to sense a vibrational acceleration of the force-based touch panel to form an acceleration signal. The vibrational acceleration adds a vibration induced signal to the at least one force sensor signal. An adaptive vibration filter is used to adaptively filter the vibration induced signal from the at least one force sensor signal by adjusting filter characteristics of the adaptive vibration filter to remove substantially all of the vibration induced signal from the at least one force sensor signal.

### CROSS-REFERENCE TO RELATED APPLICATIONS AND CLAIM OF PRIORITY

Priority of U.S. Provisional patent application Ser. No. 60/931,400 filed on May 22, 2007 is claimed, and is hereby incorporated by reference.

### BACKGROUND

Input devices (e.g., a touch panel or touch pad) are designed to detect the application of an object and to determine one or more specific characteristics of or relating to the object as relating to the input device, such as the location of the object as acting on the input device, the magnitude of force applied by the object to the input device, etc. Examples of some of the different applications in which input devices may be found include computer display devices, kiosks, games, point of sale terminals, vending machines, medical devices, keypads, keyboards, and others.

In a force-based touch panel device, the characteristics used to detect an application of an object to the device are measured by determining the force or acceleration that occurs at the device. Shaking and vibration caused by external effects other than the object on the input device are also detected as a force or acceleration that occurs at the device. Thus, when a force-based touch panel device is used in an environment that is subject to such external vibrations, the effect of the vibrations is to reduce the accuracy of a reported touch location on the input device.

One attempt to reduce the effect of external vibrations on a force-based touch panel involves a complicated process of calibrating the touch panel by taking readings from many different force and acceleration sensors while touching the touch panel in a large number of locations. These readings are then processed on a separate computer to determine a set of calibration coefficients used to correct for the vibration effects. This method requires a significant amount of user interaction to run the calibration process. Additionally, if the touch panel is moved, or the vibration environment changes, the system must be recalibrated. Thus, this method is significantly limited for practical applications.

### SUMMARY

A system and method for reducing vibrational effects on a force-based touch panel are disclosed. The method includes sensing a force applied to the touch panel using at least one force sensor to obtain at least one force sensor signal. A vibrational acceleration of the force-based touch panel is measured to form an acceleration signal. The vibrational acceleration adds a vibration induced signal to the at least one force sensor signal. The vibration induced signal is adaptively filtered from the at least one force sensor signal by adjusting filter characteristics of an adaptive vibration filter to remove substantially all of the vibration induced signal from the at least one force sensor signal to form at least one vibration-reduced force sensor signal. A location of the force applied to the touch panel from the at least one vibration-reduced force sensor signal is calculated. A user application associated with the touch panel can be updated based on the calculated location of the force on the touch panel.

A system for reducing vibrational effects on a force-based touch panel is also disclosed. The system comprises at least one force sensor operable with the force-based touch panel to measure a force applied to the touch panel to provide at least one force sensor signal. An accelerometer operable with the force-based touch panel is used to sense a vibrational acceleration of the force-based touch panel to form an acceleration signal. The vibrational acceleration adds a vibration induced signal to the at least one force sensor signal. An adaptive vibration filter is used to adaptively filter the vibration induced signal from the at least one force sensor signal by adjusting filter characteristics of the adaptive vibration filter to remove substantially all of the vibration induced signal from the at least one force sensor signal.

### BRIEF DESCRIPTION OF THE DRAWINGS

Features and advantages of the invention will be apparent from the detailed description which follows, taken in conjunction with the accompanying drawings, which together illustrate, by way of example, features of the invention; and, wherein:

FIG. 1 is an illustration of a block diagram of a system for reducing vibrational effects on a force-based touch panel in accordance with an embodiment of the present invention;

FIG. 2 is a block diagram of an additional embodiment of a system for reducing vibrational effects on a force-based touch panel;

FIG. 3 is a block diagram of another embodiment of a system for reducing vibrational effects on a force-based touch panel;

FIG. 4a is a block diagram of an adaptive vibration filtering algorithm in accordance with an embodiment of the present invention;

FIG. 4b is a block diagram of a preconditioning algorithm used with the adaptive vibration filtering algorithm in accordance with an embodiment of the present invention; and

FIG. 5 is a flow chart depicting a method for reducing vibrational effects on a force-based touch panel in accordance with an embodiment of the present invention.

Reference will now be made to the exemplary embodiments illustrated, and specific language will be used herein to describe the same. It will nevertheless be understood that no limitation of the scope of the invention is thereby intended.

### DETAILED DESCRIPTION OF EXAMPLE EMBODIMENTS

A location of a user's touch on a force-based touch panel is typically calculated using a plurality of force sensors. For example, a force sensor may be positioned at each of the four corners of the touch panel. The touch location can be determined based on the amount of force sensed by the sensors in each corner. However, external vibrations are also detected by the force-based touch panel force sensors, with the detected force being proportional to the mass of the touch panel times the acceleration caused by the vibration. The external vibration can cause noise and inaccuracies in the force sensor signals, thereby leading to an inaccurate determination of a user's touch location on the panel. The random and changing nature of external vibrations on a force-based touch panel make it difficult to reduce the vibrational effects on the touch panel.

For example, a user may touch an “enter” button that is displayed in a graphical user interface associated with the force-based touch panel to enter information into a computer. If the touch location is calculated inaccurately it may be incorrectly calculated that the enter key was not touched, thereby requiring the user to make repeated attempts to push the enter button. Thus, the ability to correctly calculate a location of a user's touch can be critical to the use of the touch panel.

It has been discovered that adaptive filtering can be used to substantially reduce and eliminate the effects of external vibrations on a force-based touch panel in order to improve the touch panel's accuracy. The use of adaptive filtering enables the inaccuracies caused by external vibrations that are detected in force sensor signals to be reduced without the need for complex and lengthy calibration procedures. Additionally, adaptive filtering enables the vibrational effects on the force sensor signals to be continuously reduced even with changes in the vibration that occur over time. Adaptive filtering can be accomplished using one or more accelerometers to measure the external vibrations. This implementation is simple and effective, enabling the use of vibrational signal reduction technology without significant additional costs to force-based touch panel products.

In one embodiment, the accelerometer can be mounted to the same structure as the touch panel, thereby enabling the accelerometer to detect substantially similar vibrations that affect the touch panel. The accelerometer is typically mounted to the support structure of the touch panel, and not to the touch panel itself. This minimizes the affect of a user's touch being detected by the accelerometer. The accelerometer can be mounted rigidly to the touch panel support structure to allow the accelerometer to accurately measure vibrations that affect the touch panel. For example, it can be mounted on a printed circuit board (PCB) that is attached to the support structure.

The accelerometer may be a micro-electro-mechanical system (MEMS) type accelerometer. Alternatively, the accelerometer may be a mass that is attached to a force sensor, such as a beam having strain sensors located on the beam to measure the force caused by the acceleration of the beam's mass.

It should be noted that the present invention is different from active vibration cancellation. Active vibration cancellation is the process of actively reducing vibrations by compensating for the vibrations with a mechanical system that is used to reduce the magnitude of vibrations. The use of adaptive filtering, as previously discussed, does not mechanically remove the external vibrations experienced by the force-based touch panel. Rather, the adaptive filtering is used to cancel or substantially reduce the effects of the vibration on the force sensor's electronic signal.

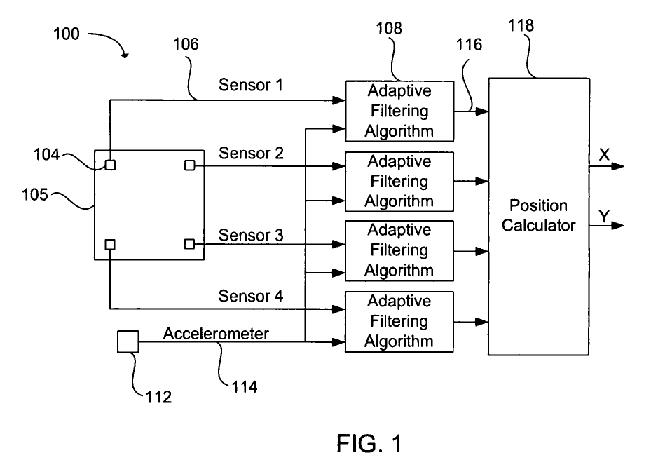

FIG. 1 provides a block diagram of a system for reducing vibrational effects on a force-based touch panel in accordance with an embodiment of the present invention. In this embodiment, four force sensors 104 are used to measure the force applied to the touch panel 105. A separate adaptive vibration filtering algorithm 108 is used for each sensor. The use of a separate algorithm at each sensor provides the ability to reduce or eliminate differing effects of the vibration on each individual force sensor signal. This can be beneficial since the effect of the vibration on each sensor signal may differ in amplitude and in phase, at a particular frequency, relative to the effect on the other force sensors.

Each adaptive vibration filtering algorithm 108 can be connected to a force sensor 104 and the accelerometer 112. A comparison of the force sensor signal 106 from each sensor with the accelerometer signal 114 can then be used to adaptively filter the effects of the vibration from each force sensor signal to output a corrected force sensor signal 116 for each force sensor signal. A position calculator 118 can then more accurately determine a location of the user's touch on the force-based touch panel based on the values of each of the corrected force sensor signals. The position calculator can output an X and a Y coordinate that corresponds to a location of the touch on the panel. Hardware, firmware, or software can then provide the proper response to the touch based on the accurately measured location of the touch on the touch panel. For example, a graphical user interface or other type of interface that is associated with the panel can be accurately updated or changed based on the location of the touch, as previously discussed.

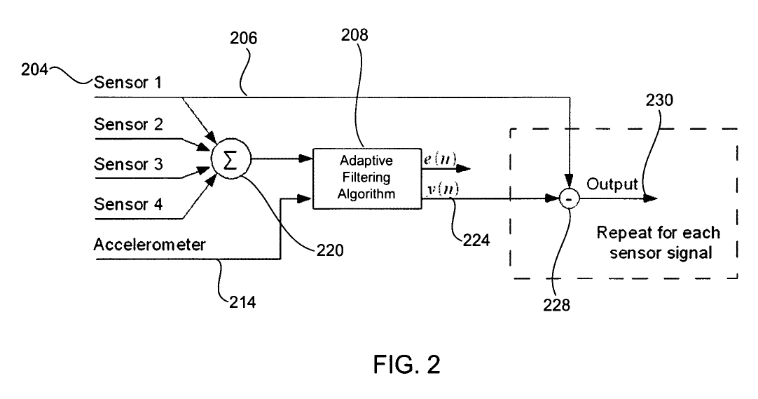

In another embodiment illustrated in FIG. 2, each force sensor signal 206 from each force sensor 204 can be summed 220 to form a linear combination of the force sensor signals. This linear combination can then be applied to a single adaptive filter 208. The adaptive filter can then be used to adaptively filter the vibration induced signal from a force sensor signal using the accelerometer signal 214 for a model of the vibration induced signal. The resulting filtered vibration signal 224 can be subtracted 228 from each of the individual sensor signals to form a corrected force sensor signal 230 for each force sensor. Since the vibration noise present in the force sensor signal is substantially correlated, the benefit of this method is that the portion of the signal that is due to vibration will add directly, but only the root mean square (RMS) of the electrical noise present in the sum of the signals will add. The effect of this is to increase the ability of the adaptive vibration filtering algorithm 208 to use the portion of the signal that is due to vibration. This improves the ability to reduce or eliminate the vibration signal from each individual force sensor signal 206. Additionally, this approach uses fewer mathematical operations per input sample. However, this approach does not allow for a different amount of correction at each force sensor 204.

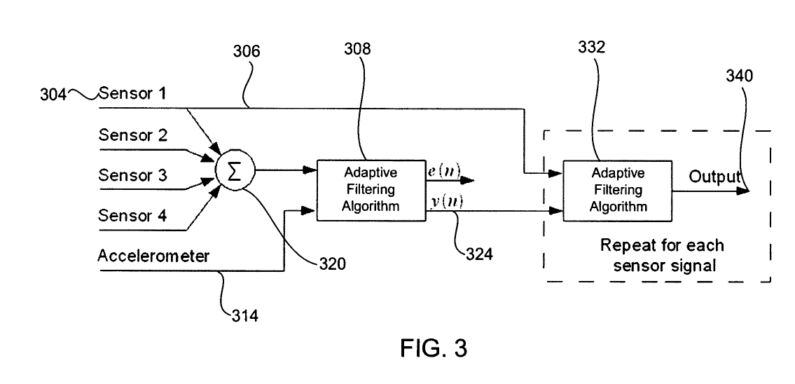

A hybrid approach to the embodiments illustrated in FIGS. 1 and 2 is shown in FIG. 3. In the embodiment of FIG. 3, an adaptive filter 308 is applied to the linear combination 320 of the force sensor signals 306 and the accelerometer signal 314. A second adaptive filter 332 is then applied to each of the individual force sensor signals 306. A noise signal 324 is output from the first adaptive filter 308 and input to the second adaptive filter. The noise signal is the correlated portion of the vibration signal determined by the first adaptive filter. The second adaptive filter is used to correct substantially any differences in the gain and phase relationships after the first adaptive filter. A corrected force sensor signal 340 can be output for each force sensor 304.

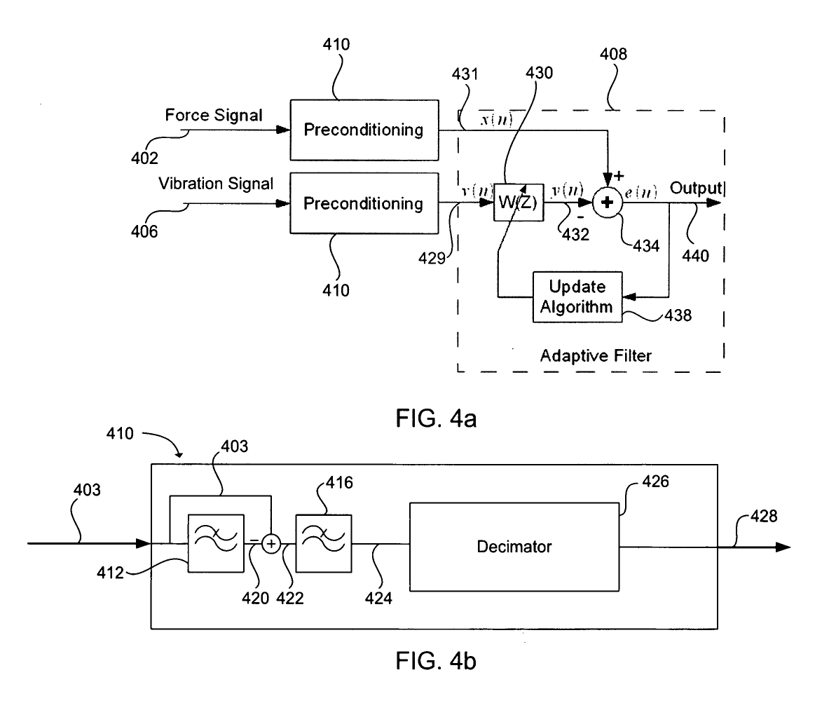

FIG. 4a illustrates a block diagram of an adaptive vibration filtering algorithm. A preconditioning algorithm 410 for the force sensor signal 402 and the vibration signal 406 are shown. The preconditioning algorithms are used to prepare each of the signals for the adaptive filter by removing any direct current (DC) offsets. Additionally, high frequency components in the signals that are not caused by a user pressing the touch panel can be removed.

It should be noted that the accelerometer may have a DC component, or may be configured such that there is no DC component. Examples of accelerometers that inherently have no DC response are piezoelectric accelerometers and dynamic accelerometers. Dynamic accelerometers have a coil that moves in a magnetic field. Accelerometers that have a DC component include piezoresistive accelerometers and some types of MEMS accelerometers that include integrated signal conditioning. The use of any of these types of accelerometers is considered to be within the scope of the present invention.

One embodiment of a preconditioning algorithm 410 is illustrated in FIG. 4b. The preconditioning algorithm can be comprised of a first low pass filter 412, a second low pass filter 416, and a decimator 420. A signal 403, such as the force sensor signal 402 or vibration signal 406, can be input to the preconditioning algorithm. A DC offset in the input signal 403 can be removed by subtracting a low-pass filtered version 420 of the input signal from itself 403, as shown. The resulting signal 422 can then be passed through the second low-pass filter to substantially remove high-frequency components in the signal that are not caused by a user pressing the touch panel.

The output 424 from the second low pass filter 416 can be input to a decimator 426 to be decimated in order to zoom in to a frequency band of interest. It should be noted that the only component of the preconditioning block that is required for the operation of the adaptive noise cancellation algorithm is the removal of the DC offset. If the output of the force sensor and the accelerometer does not have a DC offset, then the preconditioning block may not be needed.

There may be some differences in preconditioning the force sensor signal 402 and the acceleration signal 406 (FIG. 4a). For example, in one embodiment, if an accelerometer is used that includes a DC component, the DC offset in the acceleration signal can be implemented where the first low-pass filter 412 is a unity-gain filter with a cutoff frequency of 0.1 Hz. The cutoff frequency can be selected such that it is sufficiently low to not significantly effect a touch of the panel, while being high enough so that any near DC offsets due to temperature or other slow-moving non-touch effects can be removed. The cutoff frequency is typically less than 1 Hz. Alternatively, a high-pass filter can also be used to remove the accelerometer's DC offset. The DC portion of the force sensor signal 402 (FIG. 4a) can be removed using any algorithm that estimates and removes the DC offset as long as the touch data is not allowed to affect the approximation of the DC offset and the calculation is reasonably accurate. One method of removing the DC portion of the force sensor signal for a force-based touch panel is disclosed in U.S. Pat. No. 7,337,085, which is hereby incorporated by reference.

The second low pass filter 416 can be used to remove the high frequency components of the input signal. In one embodiment, a finite impulse response (FIR) filter with a 3 dB cut-off frequency of 12 Hz can be used. This cutoff frequency is set sufficiently high to pass the touch data while still rejecting noise that is not part of the touch data. Alternatively, an infinite impulse response (IIR) filter may be used with a similar cutoff frequency.

The decimator 426 can be used to reduce the number of samples that are processed by keeping one out of every N samples and discarding the remaining samples. This operation also reduces the sampling rate and effectively zooms in on the frequency spectrum by a factor of N. Also, it reduces the number of filter coefficients that are used by the adaptive vibration filtering algorithm 408 (FIG. 4a) for a given amount of noise rejection.

In order to avoid significant aliasing of the higher frequencies in the input signal 424, a trade-off is made between the decimation level and the low-pass filter cutoff frequency. For example, with a sampling rate of 800 Hz and a signal bandwidth of 40 Hz, after low-pass filtering, any decimation level that is less than or equal to ten can be used without introducing aliasing. In a typical system with a sample rate of 800 Hz, a decimation level of four can be used because the second low-pass filter doesn't substantially limit the bandwidth within 40 Hz.

In the frequency domain, the vibration that is detected by the accelerometer will typically include a number of frequencies. For example, the vibration may be substantially comprised of vibrational energy having a frequency of 18 Hz, 36 Hz, 54 Hz, and 72 Hz. Many of these frequencies will also be in the vibration induced signal in the force sensor signal. For example, the vibration induced signal, when viewed in the frequency domain, may include 18 Hz, 36 Hz, and 54 Hz. The frequencies from the vibration signal that are also in the vibration induced signal portion of the force sensor signal are referred to as correlated. Frequencies in the vibration signal that do not appear in the vibration induced portion of the force sensor signal, such as the 72 Hz component in this example, are said to be uncorrelated.

Referring again to FIG. 4a, the digital filter W(Z) 430 is used to remove the portion of the preconditioned vibration signal 429 that is not correlated with the preconditioned force sensor signal 431. The remaining correlated portion 432 of the vibration signal is then subtracted from the preconditioned force sensor signal 431. The output 440 of the adaptive vibration filter algorithm 408 is the vibration-reduced force sensor signal for a selected force sensor signal.

The coefficients of the digital filter 430 are adapted by the update algorithm 438 in such a manner that a substantially maximum amount of the correlated portion of the vibration signal 432 is removed from the force sensor signal 431. The digital filter may use any number of coefficients depending on the effect of the vibration signal 406 on the force signal 402. Although any filter length can be used, a typical implementation of the digital filter is an 8-tap FIR filter. Lower filter lengths can result in less rejection of the correlated vibration signal. The use of higher filter lengths can require more processing operations per input sample. An appropriate infinite impulse response filter may also be used.

The update algorithm 438 is defined by the type of adaptive algorithm that is selected. There are many common methods of updating the filter coefficients. An explanation of some standard methods can be found in “Fundamentals of Adaptive Filtering” by Ali H. Sayed (ISBN 0471461261) or “Adaptive Filters Theory and Applications” by Behrouz Farhang-Boroujeny (ISBN 0471983373). Standard methods include the least mean square (LMS), normalized least mean square (NLMS), affine projection adaptive filtering (APA), recursive least square (RLS), and their derivatives.

The method selected for the update algorithm 438 is dependent on various conditions, such as the speed at which frequency content of the vibration changes, the environment in which the force-based touch panel will be located, the type of hardware used to implement the algorithm, and so forth. In one embodiment, one or more of the above listed methods may be selected as the update algorithm. For example, a first method such as RLS may be selected based on the algorithms ability to quickly estimate the correlation between two signals. A second algorithm may then be used after correlation of the signals has been achieved, such as the LMS algorithm, based on its simplicity and ability to detect changes in the two signals.

Assuming that the preconditioning has already been accomplished, one embodiment for implementing the adaptive vibration filter algorithm 408 is summarized in the following algorithm.

The output 432 y(n) of the digital FIR filter 430 can be calculated using the equation:

$$y ( n ) = {\sum }_{k = 0}^{N - 1} v ( n - k ) {w}_{n} ( k ) .$$

The error output signal 440 e(n) can be calculated as:

e(n)=x(n)−y(n).

An estimate of the input signal's 429 (v(n)) power can be calculated as:

p(n)=βp(n−1)+(1−β)v(n)².

The filter coefficients 430 can then be updated using the equation:

$${w}_{n} ( k ) = {w}_{n - 1} ( k ) + \frac{μ}{ɛ + p} v ( n - k ) e ( n ) , k ∈ [ 0 , N - 1 ] .$$

The variables used in this algorithm are defined as follows:
1. N is the length (the number of taps) of the FIR adaptive filter.
2. n is the sample number (0 based).
3. k is the index of the filter coefficient vector wₙ.
4. wₙ is the 1×N adaptive filter coefficient vector at sample n.
5. x(n) is the preconditioned force input signal at sample n 431.
6. v(n) is the preconditioned vibration input signal at sample n 429.
7. p(n) is an estimate of the power contained in the vibration signal 429 v(n) at sample n.
8. e(n) is the output signal of the adaptive filter at sample n.
9. β is the coefficient used to estimate the power of the input signal. This value is limited to values between 0 and 1. Values closer to 1 give a better estimate of the input signal's power if the power is not changing rapidly. Otherwise, a smaller value is typically used.
10. μ is the adaptive algorithm step size. This is a positive value, and is typically selected to be sufficiently small to keep the algorithm from diverging when the signal power is high. However, the value should be large enough to quickly adapt to changes in the input signals. Smaller values also help to keep the changes in the force sensor signal from a user's touch from effecting the vibration rejection.
11. ε is a small number that keeps the quotient

$$\frac{μ}{ɛ + p}$$

from getting too large when the input signal's power is small. This helps to ensure the stability of the adaptive algorithm.

In one exemplary embodiment, the initial conditions used in the adaptive vibration filter algorithm are:
1. w₋₁(k)=0, kε[0, N−1]
2. p(−1)=0
3. μ=0.1
4. ε=0.00001
5. β=0.9
6. N=8

The adaptive filter update algorithm 438 can be disabled when the touch panel is pressed. Disabling the adaptive filter algorithm at the time a force is applied to the touch panel prevents the adaptive filter from attempting to filter out the data that is caused by a press on the touch panel. One possible method of enabling/disabling the update algorithm is to enable or disable the update algorithm in synchronization with the enabling/disabling of the baseline estimation as is done in some location calculation methods. This effectively stops the filter coefficients from being updated for a predetermined period. Enabling and disabling the update algorithm during a baseline estimation is disclosed in U.S. Pat. No. 7,337,085 to Soss, which is herein incorporated by reference.

Alternatively, a linear combination of the force sensor signals can used to determine when the touch panel is pressed. The update algorithm 438 can be enabled or disabled based on how the linear combination compares with a selected threshold.

The output signal 440 from the adaptive vibration filter algorithm 408 is used to calculate the location of a press on the touch panel. This algorithm can be run on the same processor that is used to process the touch panel data. Alternatively, a separate processor or specialized hardware can be used, as can be appreciated. In particular, the methods and algorithms can be performed wholly or in part through the use of analog electronic circuits.

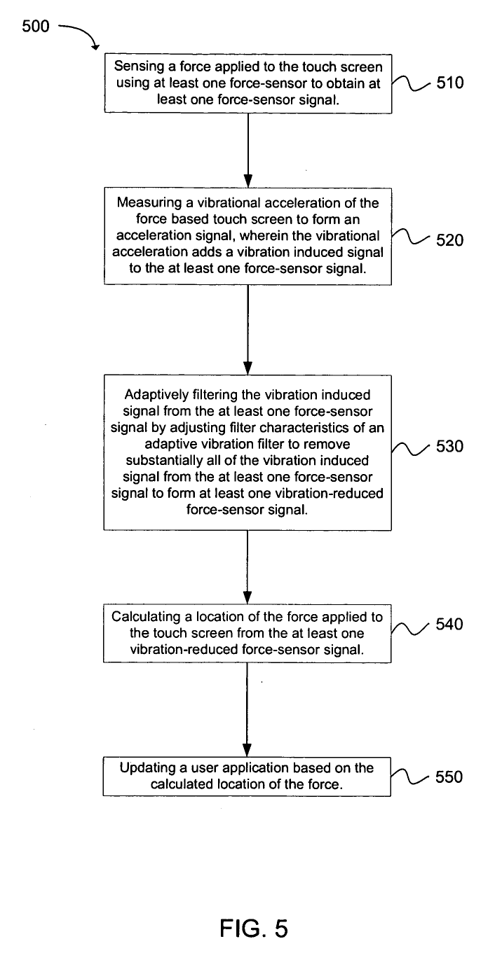

Another embodiment of the invention provides a method for reducing vibrational effects on a force-based touch panel, as depicted in the flow chart of FIG. 5. The method includes the operation of sensing 510 a force applied to the touch panel using at least one force sensor to obtain at least one force sensor signal. An additional operation involves measuring 520 a vibrational acceleration of the force-based touch panel to form an acceleration signal. The vibrational acceleration adds a vibration induced signal to the at least one force sensor signal.

Another operation of the method 500 includes adaptively filtering 530 the vibration induced signal from the at least one force sensor signal by adjusting filter characteristics of an adaptive vibration filter to remove substantially all of the vibration induced signal from the at least one force sensor signal to form at least one vibration-reduced force sensor signal. The filter characteristics of the adaptive vibration filter can be adjusted based on a correlation between the vibration induced signal and the acceleration signal.

The method 500 includes an additional operation of calculating 540 a location of the force applied to the touch panel from the at least one vibration-reduced force sensor signal. A user application can then be updated 550 based on the calculated location of the force. The update may involve a change in a graphical interface that is associated with the touch panel, such as the display of a different panel or graphical interface. Alternatively, a component in a graphical interface may be changed, moved, resized, activated, and so forth. Alternatively, a user application that does not include a display can be updated or changed based on the calculated location of the force.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

What is claimed is:

1. A method for reducing vibrational effects on a force-based touch panel, comprising:
sensing a force applied to the touch panel using at least one force sensor to obtain at least one force sensor signal;
measuring a vibrational acceleration of the force-based touch panel to form an acceleration signal, wherein the vibrational acceleration adds a vibration induced signal to the at least one force sensor signal;
adaptively filtering the vibration induced signal from the at least one force sensor signal by adjusting filter characteristics of an adaptive vibration filter to remove substantially all of the vibration induced signal from the at least one force sensor signal to form at least one vibration-reduced force sensor signal;
calculating a location of the force applied to the touch panel from the at least one vibration-reduced force sensor signal; and
updating a user application based on the calculated location of the force.

2. The method of claim 1, wherein adjusting the filter characteristics of the adaptive vibration filter further comprises adjusting the filter characteristics based on a correlation between the vibration induced signal and the acceleration signal.

3. The method of claim 1, further comprising disabling the adaptive filter when a force is applied to the touch panel to prevent the adaptive filter from attempting to filter out touch data that is caused by a press on the touch panel.

4. The method of claim 3, wherein disabling the adaptive filter further comprises disabling an update algorithm in the adaptive filter to prevent the adaptive filter from attempting to filter out touch data that is caused by a press on the touch panel.

5. A method as in claim 1, further comprising preconditioning the force sensor signal, wherein preconditioning comprises at least one of substantially removing any direct current (DC) offsets from the force sensor signal, substantially removing high frequency components of the force sensor signal, and decimating the signal to have a desired number of samples.

6. A method as in claim 5, wherein substantially removing any direct current offsets from the force sensor signal further comprises removing a direct current offset using a unity-gain filter with a cutoff frequency lower than the frequency content of a touch of the force-based touch panel.

7. A method as in claim 1, further comprising preconditioning the vibration signal, wherein preconditioning comprises at least one of substantially removing any direct current (DC) offsets from the vibration signal, substantially removing high frequency components of the vibration signal, and decimating the signal to have a desired number of samples.

8. A method as in claim 1, wherein adaptively filtering the vibration induced signal from the at least one force sensor signal further comprises adaptively filtering using a finite impulse response filter having a plurality of coefficients.

9. A method as in claim 8, further comprising updating the plurality of coefficients using a model selected from the group consisting of least mean square (LMS), normalized least mean square (NLMS), affine projection adaptive filtering (APA), and recursive least square (RLS).

10. A method as in claim 9, further comprising updating the plurality of coefficients using the equation:
$${w}_{n} ( k ) = {w}_{n - 1} ( k ) + \frac{μ}{ɛ + p} v ( n - k ) e ( n ) , k ∈ [ 0 , N - 1 ]$$

11. The method of claim 1, further comprising:
summing a plurality of force sensor signals to form a linear combination force sensor signal;
correlating the linear combination force sensor signal with the acceleration signal using an adaptive vibration filter having the linear combination force sensor signal and the acceleration signal as inputs to adaptively filter the vibration induced signal from the linear combination force sensor signal to form a filtered vibration signal; and
subtracting the filtered vibration signal from each of the force sensor signals in the plurality of force sensor signals to form a plurality of corrected force sensor signals.

12. The method of claim 1, further comprising:
summing a plurality of force sensor signals to form a linear combination force sensor signal;
correlating the linear combination force sensor signal and the vibration signal using a first adaptive vibration filter having the linear combination force sensor signal and the acceleration signal as inputs to adaptively filter the vibration induced signal from the linear combination force sensor signal to form a filtered vibration signal;
adaptively filtering the vibration induced signal from a selected one of the plurality of force sensor signals using a second adaptive vibration filter having the filtered vibration signal and the selected force sensor signal as inputs to adaptively filter the vibration induced signal from the selected force sensor signal to form a corrected force sensor signal for the selected force sensor signal.

13. A system for reducing vibrational effects on a force-based touch panel, comprising:
at least one force sensor operable with the force-based touch panel to measure a force applied to the touch panel to provide at least one force sensor signal;
an accelerometer operable with the force-based touch panel to sense a vibrational acceleration of the force-based touch panel to form an acceleration signal, wherein the vibrational acceleration adds a vibration induced signal to the at least one force sensor signal;
an adaptive vibration filter that adaptively filters the vibration induced signal from the at least one force sensor signal by adjusting filter characteristics to remove substantially all of the vibration induced signal from the at least one force sensor signal.

14. The system of claim 13, wherein the accelerometer has no direct current response and is selected from the group consisting of a piezoelectric accelerometer and a dynamic accelerometer, and the accelerometer.

15. The system of claim 13, wherein the accelerometer has a direct current response and is selected from the group consisting of a piezoresistive accelerometer, a micro-electro-mechanical system (MEMS) accelerometer based on capacitive sensing, and a MEMS sensor based on piezoelectric sensing.

16. The system of claim 13, wherein the accelerometer is attached to a structure to which the force-based touch panel is mounted to enable the accelerometer to accurately sense the acceleration of the force-based touch panel while minimizing detection of movement caused by the force applied to the touch panel.

17. The system of claim 13, wherein the adaptive vibration filter includes a finite impulse response filter having a plurality of coefficients.

18. The system of claim 17, wherein the finite impulse response filter has at least 4 coefficients.

19. The system of claim 18, wherein the coefficients are updated based on a model selected from the group consisting of least mean square (LMS), normalized least mean square (NLMS), affine projection adaptive filtering (APA), and recursive least square (RLS).

20. The system of claim 13, further comprising:
a plurality of force sensor signals summed to form a linear combination force sensor signal;
the adaptive vibration filter having the linear combination force sensor signal and the acceleration signal as inputs to adaptively filter the vibration induced signal from the linear combination force sensor signal to form a filtered vibration signal; and
means for subtracting the filtered vibration signal from each of the force sensor signals in the plurality of force sensor signals to form a plurality of corrected force sensor signals.

21. The system of claim 13, further comprising:
a plurality of force sensor signals summed to form a linear combination force sensor signal;
a first adaptive vibration filter having the linear combination force sensor signal and the acceleration signal as inputs to adaptively filter the vibration induced signal from the linear combination force sensor signal to form a filtered vibration signal;
a second adaptive vibration filter having the filtered vibration signal and a selected force sensor signal from the plurality of force sensor signals as inputs to adaptively filter the vibration induced signal from the selected force sensor signal to form a corrected force sensor signal for the selected force sensor signal.

22. A system for reducing vibrational effects on a force-based touch panel, comprising:
means for sensing a force applied to the touch panel to obtain at least one force sensor signal;
means for measuring a vibrational acceleration of the force-based touch panel to form an acceleration signal, wherein the vibrational acceleration adds a vibration induced signal to the at least one force sensor signal;
means for adaptively filtering the vibration induced signal from the at least one force sensor signal to remove substantially all of the vibration induced signal from the at least one force sensor signal to form at least one vibration-reduced force sensor signal;
means for calculating a location of the force applied to the touch panel from the at least one vibration-reduced force sensor signal; and
means for updating a user application based on the calculated location of the force.
